(19) United States
(12) Patent Application Publication
(10) Pub. No.: US 2007/0239997 A1
(43) Pub. Date: Oct. 11, 2007

(54) METHOD FOR UNIFIED COMMUNICATION BETWEEN MULTIPLE MEDICAL INFORMATION SYSTEMS

(76) Inventors: Jianming QU, Chengdu (CN); Lixin PU, Chengdu (CN); Jiongfeng YANG, Chengdu (CN); Fangming DUAN, Chengdu (CN)

Correspondence Address: MATTHIAS SCHOLL, 14781 MEMORIAL DRIVE, SUITE 1319, HOUSTON, TX, 77079, US

(21) Appl. No.: 11/696,791

(22) Filed: Apr. 5, 2007

(30) Foreign Application Priority Data
Apr. 7, 2006 (CN) 200610020660.1

(51) Int. Cl. G06F 12/14

(52) U.S. Cl. 713/193

(57) ABSTRACT

The invention discloses a method for unified communication between multiple medical information systems. In accordance with the method of the invention, an isomerous gateway pool comprises multiple servers connected to the clients ports of various medical information systems via network ports. The network ports of a the gateway pool are connected to a network interface module and the information of various medical information systems is transformed by the servers via information analysis modules and information building modules into information conforming to an international electronic medical information standard. The information is then intercommunicated between various medical information systems. By applying the method taught by the invention, the intercommunication of information between various medical information systems is realized, and the problem of Information Island is solved, the work efficiency of medical systems is increased largely, and the information communication between various medical systems is improved, which is beneficial to the patients and the development of the medical profession.

### CROSS-REFERENCE TO RELATED APPLICATIONS

Pursuant to 35 U.S.C §119 and the Paris Convention Treaty, this application claims the benefit of Chinese Patent Application No. 200610020660.1 filed Apr. 7, 2006, the contents of which are incorporated herein by reference.

### BACKGROUND OF THE INVENTION

1. Field of the Invention

This invention relates to methods for unified communication between multiple medical information systems and, more particularly, to transforming the information of various electronic medical information systems into information conforming to an international electronic medical information standard.

2. Description of the Related Art

Modern medical systems are complicated organizations which include various functional sectors and offices. Correspondingly, the information systems are categorized into a variety of categories, such as hospital information systems, inspection information systems, electronic medical records, radiology department information systems, and the like. Generally, these information systems are incompatible with each other resulting in a status of mutual independence. The entire medical system is not planed out as one unit, and thus is lacking integration and operational flow. In addition, the problem of the Information Island is existed owing to the inconsistency of interface standards between these information systems.

Conventionally, if information needed to be communicated between the various medical information systems, it could only be communicated through speech or through exchanging written materials between professionals belonging to the various information systems. It is not only inconvenient but also inefficient to manage the communication interactions in this way and this type of exchange also leads to potential medical accidents due to misunderstandings and errors. Moreover, since conventional medical systems are not generally standardized, it is difficult to transmit medical information over a network, which ultimately does not benefit the medical profession and the patients.

Therefore, it is desirable to assure conformance of information to be communicated between the various medical information systems to an international electronic medical information standard, for example, the current mature HL7 international information standard, and based on the standard to provide information exchange interfaces so as to realize mutual information sharing.

### SUMMARY OF THE INVENTION

The invention arose in the context of the above problems. Specifically, it is one objective of the invention to provide a method for unified communication between multiple medical information systems.

To achieve the method for unified communication between multiple medical information systems provided is an isomerous gateway pool comprising several servers and connecting to the client ports of various medical information systems via its network ports. The network ports of the isomerous gateway pool are connected to a network interface module; and the servers inside of the gateway pool process information via the following steps:

1) Verifying inputted information by a verification module to determine whether it conforms to an international electronic medical information standard.

If the information conforms to the international electronic medical information standard, replying to the application layer according to the international standard.

If the information does not conform to the international electronic medical information standard, sending the information to the information analysis module; then analyzing the metadata of the received information to check whether the received information needs to be processed manually. If the information needs to be processed manually, writing the information to a database as required; and sending a notice to the user interface of the application system. If the information does not needed to be processed manually, providing a trigger mechanism and sending it to the information building module.

2) For the output information, receiving triggers from (i) a trigger mechanism of an information analysis module or an application system, and (ii) the automatic update of the system itself.

If a trigger is received from the trigger mechanism of the information analysis module, building the information strictly according to the information specified by the international electronic medical information standard in the information building module, and accessing the database on demand to generate corresponding standard information.

If a trigger is received from the automatic update of the system, building the standard information conforming to the international electronic medical information standard in the information building module; then sending the standard information to the client ports of various medical information systems via the network interface module and network ports after verifying it by the verification module.

In certain embodiments of the invention, the international electronic medical information standard is HL7.

In accordance with certain embodiments of the invention, an encryption and decryption module is disposed between the verification module and the network interface module to insure security of the medical information. In the software module of the servers inside of the isomerous gateway pool, the information is processed by means of symmetric encryption. For specific applications, the information is encrypted by means of DES (Data Encryption Standard) symmetric encryption. The symmetric encryption key is encrypted by means of RSA (Rivest, Shamir, and Adleman) asymmetric encryption, ensuring both data safety and efficiency.

In certain embodiments of the present day inventions, the operation of the isomerous gateway pools adopts the principle of load and balancing operations. Namely, many servers combine to form a server set in a manner of symmetry. By examining the loads (such as the CPU, memory usage) inside of the gateway pool to determine the less loaded or idle server, the information is distributed to certain less-loaded or idle servers. All servers have equal status, and each server can provide service separately without the assistance of other servers. The server receiving information can reply to the client ports independently. In this way, information processing can be distributed effectively and rationally to the various servers inside of the gateway pool.

In certain embodiments of the invention, a gateway pool provides connection information to various servers. The connection information and format information of the databases are in separate places, and the information format supported by the international electronic medical information standard is in the form of a configurational file. The configurational file can be read dynamically during the operation of the program and modified freely according to demand, and without influencing the normal operation of the gateway pool. This is done so as to realize the dynamic extension of the number of client ports to be connected and the function of the gateway pool. By modifying the configurational file of the information conforming to the international electronic medical information standard, the version of the international electronic medical information standard supported by the gateway pool can be updated.

In the operation of databases of various servers inside of the isomerous gateway pool, a certain form of the configurational file is adopted to generate data obtained through information analysis in a structural query language (SQL). The operation of database comprises two parts: the first responsible for operating the database directly by executing specific SQL statements, including inserting, modifying, deleting, and querying the SQL module (this is essential when the software needs to use the database); the other responsible for generating data obtained via information analysis. Using the key value of the data sheet, information, such as information service type (for expressing the target client of the information), table name, column name, and database operation types in the configuration files, is obtained through information analysis. The obtained information is then added to the SQL template, wherein the structural query language of random length can be generated automatically according to the information content.

As a result, the transformation of information using various medical information systems into information conforming to the international electronic medical information standard is realized, the problem of Information Island is solved, the work efficiency of the medical system is largely increased, and the information communication between various medical systems is improved.

### BRIEF DESCRIPTION OF THE DRAWINGS

The invention is described hereinbelow with reference to accompanying drawings, in which:

FIG. 1 is a structural diagram illustrating a relationship between an isomerous gateway pool and various information systems in accordance with one embodiment of the invention; and

FIG. 2 is a diagram illustrating software moduli of an isomerous gateway pool and the servers inside a gateway pool in accordance with one embodiment of the invention;

FIG. 3 is a format rule of a data field configuration file in accordance one embodiment of the invention;

FIG. 4 is a format of a database configuration file in accordance with one embodiment of the invention; and

FIG. 5 is a format of a data field—database mapping configuration file in accordance with one embodiment of the invention.

### DETAILED DESCRIPTION OF THE EMBODIMENTS

The method for unified communication between multiple medical information systems in accordance with the invention will be described further hereinafter referring to the related drawings.

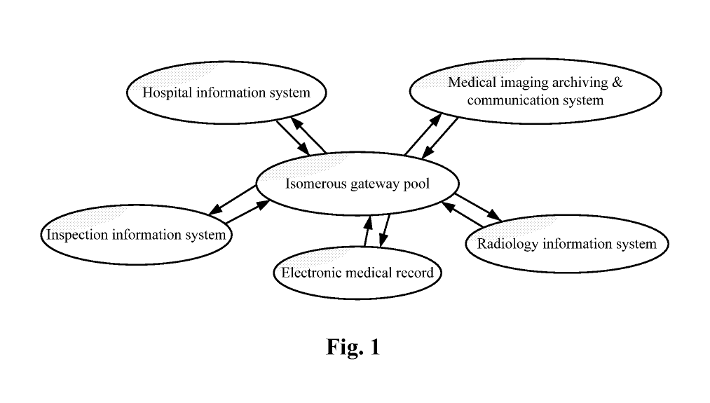

As illustrated in FIG. 1, a multiple information system, as exemplified with referenced to a hospital, includes a hospital information system, an inspection information system, an electronic medical record, a radiology information system, and a medical imaging archiving & communication system. In accordance with a method of the invention, an isomerous gateway pools comprises several servers set up and connected to client ports of the various medical information systems via network ports so as to realize information intercommunication between the information systems.

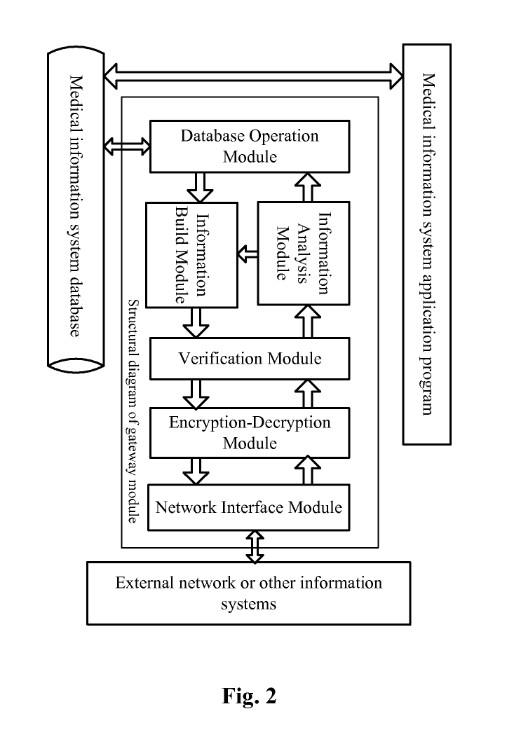

As shown in FIG. 2, the network port of the isomerous gateway pool is connected to a network interface module. The network interface module identified the less-loaded or idle servers by examining the loads (such as the CPU, memory usage) of various servers inside of the gateway pool, and then sends the input information to the less loaded or idle server for processing. The software module of the servers inside of the gateway pool comprises an encryption and decryption module, a verification module, an information analysis module, an information building module, a database operation module, a database, and a terminal application program, wherein the information analysis module and the information building module are core modules.

The operation of the information analysis module and the information building module are described below with reference to the HL7 V2.3.1 standard. In order to expand flexibly the processing capability of the gateway to information, two kinds of configuration text files are adopted: (i) a configuration text file for mapping HL7 data fields (as shown in FIG. 3), and (ii) a configuration text file for formatting the HL7 information.

Because the HL7 standard information can be divided into the following four groups: information segment, data field, component, and subcomponent, and the information segment and the data field are repeatable, it can be mapped via a six-staged structure. For example, the meaning of the mapping rule of “hospitalization number=PID0.3.R0.1.0. MR” (as shown in FIG. 3) is as follows: “.” is a separating character; the mapping identification is divided into six stages of “PID0”, “3”, “R0”, “1”, “0”, and “MR” via the separating character “.”. The first stage “PID0” represents the first PID information segment of the information; the second stage “3” represents the third data field of the information segment; the third stage “R0” represents repeatable data field, wherein “0” represents that there is no repeat, while other number n represents the repeat of that n^{th} number; the fourth stage “1” represents the first element of the data field; the fifth stage “0” represents the 0^{th} subcomponent, namely the only subcomponent; the sixth stage “MR” represents the self defined functional adaptive character, which is an optional mapping structure.

The following is an example of an actual medical file information relating to a CT chest examination of patient Guan Yu by doctor Hua Tuo:
“MSH [symbol] ˜\&| local system| local node| remote system| remote node|
20060112174344.0503+0800∥ ORM [symbol] O01∥D|2.3.1<cr>
PID|∥456456 [symbol] MR∥Guan Yu∥19680101|Male<cr>
PV1|∥ Orthopedic Department [symbol] 18<cr>
ORC|NW<cr>
OBR∥20060112007∥CT|∥∥∥∥ archery wound 5 days on right upper arm. 4 days after scrapping the position off the bone. Suspecting pulmonary infection. ˜Archery wound on the right upper arm∥ chest| Hua Tuo <cr>

The third data field (italic script) of the PID segment of the information—456456 [symbol] MR, has the mapping rule of “hospitalization number=PID0.3.R0.1.0. MR” (as shown in FIG. 3), representing that when analyzing the information, a data pairs of “PID0.3.R0.1 0.MR=456456” is generated, which means that the first element under the third data field of the first PID segment of the information represents the hospitalization number of the patient, which is 456456.

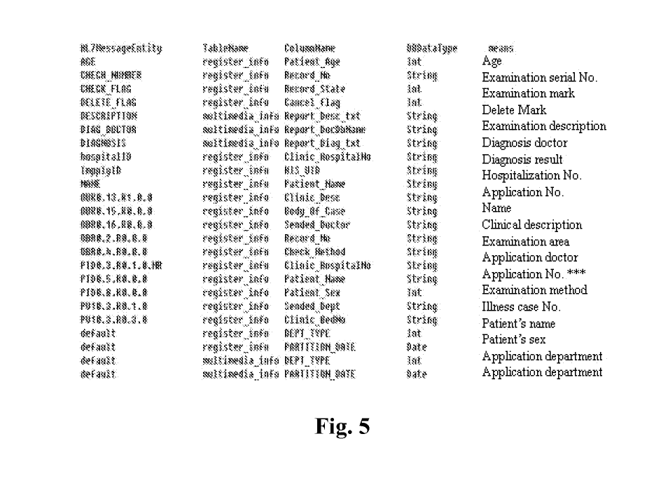

Besides, the fourth data field (italic script) of the OBR information segment—CT, has the mapping rule of “examination area=OBR0.4.R0.0.0 (as shown in FIG. 3). Similarly, when analyzing the information, a data pair of OBR0.4.R0.0.0=CT is generated. If the mapping rule is related directly with the data field in the database (the rule is shown in FIG. 5), the SQL language for processing the database can be generated directly.

When building the information, the introduced mapping rule of “PID0.3.R0.1.0.MR=Hospitalization number” can be divided into two mappings, namely, PID0.3.R0.1.0=data of hospitalization number and PID0.3.R0.1.5=MR, respectively. These two mappings are one combined pair that cannot be built separately. If the value of PID0.3.R0.1.0.MR is 456456, the build result of the information is that the third data field of the first PID information segment presents the same content of “456456 [symbol] MR”

Similarly, to the mapping rule of “OBR0.4.R0.0.0=examination area”, if the value of the OBR0.4.R0.0.0 is CT, the fourth data field of the first OBR information segment will present the same content of “CT”.

If the mapping rule is related directly with the data field in the database (the rule is shown in FIG. 5), the data can be extracted directly from the corresponding data field in the database to build the information according to the mapping rule.

Information format: the information type is defined in the HL7 standard, such as the above mentioned ORM̂O01 information type, wherein the information segment is not fixed, and some of the segments are repeatable or optional. In the present embodiment, two kinds of analysis models are applied: one is to validate the received information according to the format specified according to the HL7 standard, so as to ensure that the information conforming to the HL7 standard from third party can pass the validation of format syntax; the other is to solidify relatively the formation of the generated HL7 information according to the specification of the HL7 standard, wherein the optional and repeatable segments are removed, so as to form a strict syntax for information building, and thereby, to avoid unexpected error risk. Regarding to the sending of repeatable information segments, the continuous protocol of the HL7 standard will be used to send many information having the same format.

For example, for the information of ORM [symbol] O01, the HL7V2.3.1 standard recommends the information of “MSH [{NTE}] [PID [PD1] [{NTE}] [PV1 [PV2] [{IN1 [IN2][IN3]}][GT1][{AL1}]]]{ORC [OBR [{NTE}][{DG1}][{OBX [{NTE}]}]]{[CTI]}[BLG]}, wherein the contents included in the [ ] brackets are optional, while those included in the { } brackets are repeatable.

When building the information, the fields “MSH, PID, PV1, ORC, OBR, BLG” are used, wherein the mandatory information segments in the standard, MSH and ORC, are included, while other segments, PID, PV1, OBR, and BLG are optional. Therefore, this format conforms to the HL7 standard, so that it can pass the validation according to the standard.

The servers inside of the gateway pool process the information via the following steps:

1) Decrypting inputted information by the encryption-decryption module.

2) Verifying the inputted information by a verification module to determine whether it conforms to an international electronic medical information standard, e.g., HL7.

If the information conforms to the international electronic medical information standard, replying to the application layer according to the international standard.

If the information does not conform to the international electronic medical information standard, sending the information to the information analysis module; then analyzing the metadata of the received information to check whether the received information needs to be processed manually. If the information needs to be processed manually, writing the information to a database as required; and sending a notice to the user interface of the application system. If the information does not needed to be processed manually, providing a trigger mechanism and sending it to the information building module.

2) For the output information, receiving triggers from (i) a trigger mechanism of an information analysis module or an application system, and (ii) the automatic update of the system itself.

If a trigger is received from the trigger mechanism of the information analysis module, building the information strictly according to the information specified by the international electronic medical information standard in the information building module, and accessing the database on demand to generate corresponding standard information.

If a trigger is received from the automatic update of the system periodically, automatically building the standard information conforming to the international electronic medical information standard in the information building module; encrypting the standardized information, wherein the information is encrypted by DES symmetric encryption and the symmetric encryption key is encrypted by RSA asymmetric encryption, via the encryption and decryption module; and then sending the standard information to the client ports of various medical information systems via the network interface module and network ports after verifying it by the verification module.

As shown in FIG. 2, the connection information of the various servers of the gateway pool, the connection information and format information of the databases in different locations, and the information format supported by the international electronic medical information standard are all in the form of a configuration file. The configuration file can be read dynamically during the operation of the program and modified freely according to the demand of the hospital, without influencing the normal operation of the gateway pool. By modifying the configuration file of the information conforming to the international electronic medical information standard, the version of the international electronic medical information standard supported by the gateway pool can be updated.

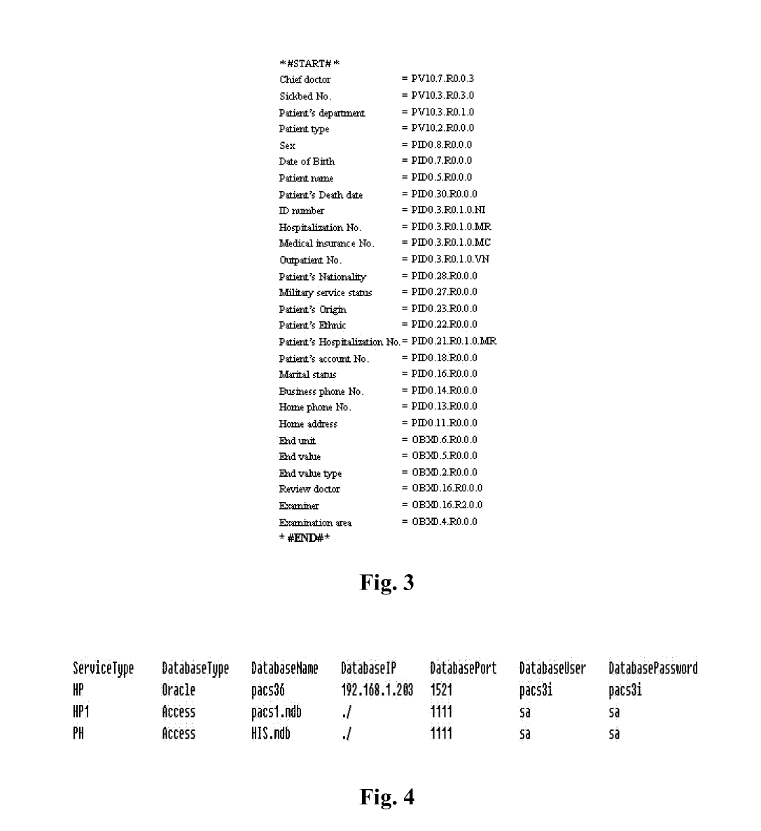

As shown in FIG. 2, in the operation of databases of various servers inside of the isomerous gateway pool, certain forms of “database configuration file” (as shown in FIG. 4), and “data field—database mapping” (as shown in FIG. 5) are adopted to generate data obtained through information analysis in a structural query language (SQL); and the authority to operate the database according to the user authority in the database configuration file is ascertained (as shown in FIG. 4). The operation of database comprises two parts: the first responsible for operating the database directly by executing specific SQL statements, including inserting, modifying, deleting, and querying the SQL module (this is essential when the software needs to use the database); the other responsible for generating data obtained via information analysis. Using the key value of the data sheet, information, such as information service type (for expressing the target client of the information), table name, column name, and database operation types in the configuration files, is obtained through information analysis via the configuration file of data field—database mapping. The obtained information is then added to the SQL template, wherein the structural query language of random length can be generated automatically according to the information content.

The various servers inside of the isomerous gateway pool conform to the cluster mechanism. By the operation principle of load balancing, to examine the loads (such as the CPU, memory usage) of various servers inside of the gateway pool, the network interface module distributes dynamically the information to the less loaded server for processing so as to realize load balancing. If a certain server in the gateway pool breaks down, the operation of the gateway pool will not be influenced; moreover, additional servers can be added on-line. Besides, the whole gateway pool only provides one IP address and port number for external connection. In this way, the stable and fast service of the gateway pool is guaranteed.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

What is claimed is:

1. A method for providing unified communication between multiple medical information systems comprising providing
an isomerous gateway pool comprising several servers having network ports and being connected to client ports of said medical information systems via said network ports; said network ports of the isomerous gateway pool being connected to a network interface module;
an application system comprising an application layer, an encryption-decryption module; a verification the module; an information analysis module having a trigger mechanism; an information building module; and a network interface module;
a user interface; and
a database;
wherein said servers process information via steps comprising:
a) decrypting an inputted information by said encryption-decryption module;
b) verifying said inputted information by said verification the module to determine whether it conforms to an international electronic medical information standard;
c) if the information conforms to the international electronic medical information standard, replying to said application layer according to the international standard;
d) if the information does not conform to the international electronic medical information standard, sending the information to said information analysis module; then analyzing a metadata of the received information to check whether the received information needs to be processed manually; if the information needs to be processed manually, writing the information to said database, and sending a notice to said user interface; if the information does not need to be processed manually, providing a trigger mechanism and sending it to said information building module;
e) receiving triggers from (i) said trigger mechanism of said information analysis module or said application system, and (ii) an automatic update of the system itself:
f) if a trigger is received from said trigger mechanism of said the information analysis module, building information strictly according to the information specified by the international electronic medical information standard in said information building module, and accessing the database on demand to generate a corresponding standardized information;
g) if a trigger is received from said automatic update of said system periodically, automatically building said standardized information conforming to said international electronic medical information standard in said information building module; encrypting said standardized information, wherein said information is encrypted by DES symmetric encryption and a symmetric encryption key is encrypted by RSA asymmetric encryption by said encryption and decryption module; and then sending said standard information after verifying it by said verification module to said client ports of said medical information systems via said network interface module and said network ports.

2. The method of claim 1, wherein said encryption and decryption module is disposed between the verification module and the network interface module in the software module of the servers inside of said isomerous gateway pool, and processes the information by means of symmetric encryption.

3. The method of claim 1, wherein the operation of said isomerous gateway pool is a load balancing operation.

4. The method of claim 1, wherein the connection information of various servers of said gateway pool, the connection information and format information of the databases in different locations, and said information format supported by the international electronic medical information standard are all in a form of a configuration file.

5. The method of claim 1, wherein the international electronic medical information standard is HL7.

6. The method of claim 4, wherein the configurational file is adopted to generate data obtained through information analysis in a structural query language (SQL).

7. The method of claim 1, wherein said database is transformed in two steps, step 1 comprising operating the database directly by executing specific SQL statements, and step 2 comprising generating data obtained via information analysis.

8. The method of claim 7, wherein step 1 comprises inserting, modifying, deleting, and querying an SQL module.

9. The method of claim 7, wherein step 2 comprises obtaining data selected from the group consisting of information service type, table name, column name, and database operation type.
